(19) United States
(12) Patent Application Publication
(10) Pub. No.: US 2007/0218275 A1
(43) Pub. Date: Sep. 20, 2007

(54) Multi-layered environmentally friendly sheet material and products made therefrom

(76) Inventors: James H. Parris, Linthicum, MD (US); Robert J. Schaefer, Nottingham, MD (US); Kelvin T. Okamoto, Arlington Heights, IL (US)

Correspondence Address: BANNER & WITCOFF, LTD., TEN SOUTH WACKER DRIVE, SUITE 3000, CHICAGO, IL, 60606, US

(21) Appl. No.: 11/384,214

(22) Filed: Mar. 17, 2006

(51) Int. Cl. B32B 27/18

(52) U.S. Cl. 428/339; 428/411.1; 428/480

(57) ABSTRACT

An environmentally friendly sheet material, and thermoformed products made with that material. The two-, three- or four layer environmentally friendly sheet material is especially suited for use in connection with the manufacture of cups and similar containers and products. In a two-layer compostable sheet, the first layer is a relatively thick layer containing up to 50% additive. The second layer is a relatively thin layer of substantially clear compostable material. The two-layer sheet material is preferably made by co-extruding the first and second layers together. The multi-layer material and the products therefrom of the invention exhibits surprisingly high gloss levels on one side thereof.

### TECHNICAL FIELD

The invention relates to an environmentally friendly sheet material having at least two layers, and to thermoformed products made from that material. The most preferred environmentally friendly material is polylactic acid, and the sheet material is suitable for the manufacture of many products. Thermoformed products, including but not limited to disposable cups and containers, can be made of this sheet material.

### BACKGROUND OF THE INVENTION

Every year, billions of disposable food containers, including but not limited to cups and plates, are sold throughout the world. These containers are made of many different kinds of materials.

Many of these containers are made, however, of non-compostable, non-biodegradable or otherwise non-environmentally friendly polymers. As used herein, the term “environmentally friendly” means materials that are compostable and/or biodegradable Hence, disposable containers made of non-environmentally friendly polymers increase landfill volume for both municipal and privately-run dumps and disposal sites, whereas products made from environmentally friendly polymers can be diverted from landfills to processing centers where they may be composted or otherwise broken down or recycled. Compostable and non-compostable plastics can be differentiated by the use of ASTM D6400, as is known in the art.

Currently, polystyrene is a preferred polymeric material of construction for disposable containers. Polystyrene (PS) is durable, inexpensive, relatively simple to manufacture, and cosmetically attractive. In connection with the manufacture of such containers, a thin gloss layer of general purpose polystyrene (GPPS) may be added to the outside of a cup. In manufacturing such PS cups, the gloss (or second) layer is made of a polystyrene that differs from the polystyrene used in the main structural (or first) layer, which first layer is usually high impact polystyrene (HIPS). The GPPS used for the gloss layer is chosen specifically because of its clarity and gloss or reflectivity. However, polystyrene is non-compostable under ASTM D6400.

Other plastic materials presently widely used to make disposable food containers include polypropylene (PP), polyethylene (PE), and polyethylene terephthalate (PET).

Various compounds have been proposed and used in connection with the manufacture of compostable containers, cups, and other products. For example, U.S. Pat. No. 6,926,197 discloses a compostable polyethylene/starch. U.S. Pat. No. 6,878,199 is directed to a compostable pre-gelled starch suspension. A compostable non-modified starch is disclosed in U.S. Pat. No. 6,805,823. U.S. Pat. No. 6,482,872 is directed to compostable plastics.

Polylactic acid is one of a group of polymers made from renewable resources, and particularly made from plants or plant products. As but one example, polylactic acid is made from corn. The compostability of certain polylactic acid resins is disclosed in various publications, including but not limited to U.S. Pat. No. 6,987,139. However, until now, products made from polylactic acid materials have not provided manufacturers with all of their preferred structural, cost, and cosmetic characteristics.

Thus, there is a need for products, made of an environmentally friendly material, such as polylactic acid, that is suitable for the manufacture of high-quality, inexpensive, and attractive containers.

### SUMMARY OF THE INVENTION

In one embodiment, the material of the present invention is a two-layer sheet, wherein the first layer is comprised of a environmentally friendly material, such as polylactic acid, and an additive; and the second layer is comprised of a substantially clear environmentally friendly material, such as polylactic acid. The first and second layers may be made of the same material, or of a different material.

This layer of substantially clear environmentally friendly material creates what may be termed a “clear, gloss cap layer.” The most preferred additive is a colorant. It will be noted that any colorant, including a dye or pigment, may be used in the practice of the present invention.

However, in another embodiment of the invention, the additive is preferably selected from the group consisting of a filler, a fiber, or a nucleator. When a filler is used as an additive, the filler is selected from the group including talc, mica, calcium carbonate, clay, glass bead, and vermiculite.

In one embodiment of the two-layer sheet material, colorant is preferably placed in the first layer in an amount of between 0.25% and 10% by weight In one embodiment of the two-layer sheet material, the filler or reinforcing agent is preferably placed in the first layer in an amount of between 0.5% and 50% by weight. In one embodiment of the two-layer sheet material, nucleating agent is preferably placed in the first layer in an amount of between 0.25% and 2% by weight

Preferably, the first layer is substantially thicker than the second layer. In particular, in one embodiment, the first layer in the finished product has a thickness in excess of 0.005 inch. More particularly, the first layer of the finished product may have a preferred thickness ranging from 0.010 inch to 0.100 inch. The second layer in the finished product may have a preferred thickness ranging from 0.0005 inch to 0.010 inch. More particularly, the second layer of the finished product may have a preferred thickness ranging from 0.001 to 0.005 inch.

The two-layer sheet material in one embodiment is preferably made by extruding the first layer, and thereafter extruding the second layer onto the first layer.

One of the advantages of the two-layer sheet material according to one embodiment is that it provides a superior gloss, as compared with prior known polylactic acid sheet materials. In fact, the two-layer sheet material of the invention increases the gloss of polylactic acid sheet materials by a factor of about 2, as compared with a conventional one-layer polylactic acid sheet.

In general, the sheets manufactured in accordance with the invention have a gloss in excess of 50, as measured on a Novo-Curve Rhopoint small area glossmeter at a 60 degree measurement angle. In a more preferred embodiment, sheets manufactured in accordance with the invention have a gloss in excess of 60. In the most preferred embodiment, sheets manufactured in accordance with the invention have a gloss in excess of 75. This gloss is measured on at least one exposed side of the sheet material of the invention.

The preferred embodiment of the invention contains at least two layers: a thicker layer with an additive, and a thinner, clear layer. It will be understood, however, that the invention, and products made with the invention, may include three or more layers and that those layers may be the same thickness or different thicknesses. For example, a three-layer sheet or cup in accordance with the invention may include, as a first layer, an exposed, clear gloss cap layer; as a second layer, an intermediate, layer that includes a colorant, filler, or reinforcing agent; and as a third layer, an exposed layer.

Alternatively, a four-layer sheet or cup in accordance with the invention may include, as a first layer, an exposed, clear gloss cap layer; as a second layer, a first intermediate, polylactic acid layer that includes a colorant, filler, or reinforcing agent; as a third layer, a second intermediate layer; and as a fourth layer, an exposed layer.

A suitable grade of polylactic acid for the present invention (a) should have sufficient melt strength so that the sheet may be extruded and thermoformed; and (b) will preferably be amorphous.

The present invention also includes products manufactured from the aforementioned sheet materials

Other features and advantages of the invention will be apparent from the following specification.

### BRIEF DESCRIPTION OF THE DRAWINGS

FIG. 1. shows a cross-sectional view of one embodiment of a two-layer sheet material of the present invention.

FIG. 2. shows a cross-sectional view of one embodiment of a three-layer sheet material of the present invention.

FIG. 3. shows a cross-sectional view of one embodiment of a four-layer sheet material of the present invention.

FIG. 4. shows a cup manufactured from the two-layer sheet material of FIG. 1.

FIG. 5. shows a cup manufactured from the three-layer sheet material of FIG. 2.

FIG. 6. shows a cup manufactured from the four-layer sheet material of FIG. 3.

### DETAILED DESCRIPTION OF A PREFERRED EMBODIMENT

This invention has many different embodiments, in many different forms. This specification will describe in detail preferred embodiments of the invention. It will be understood, however, that this disclosure is to be considered as but one example of the principles of the invention. This disclosure is not intended to limit the broad aspect of the invention to the disclosed embodiments.

In one embodiment, the material of the present invention comprises a multi-layered sheet including a environmentally friendly material. This sheet material can be used for the manufacture of many different products, including disposable containers, and can preferably be used for the manufacture of cups and lids. Examples of environmentally friendly materials that may be used in the practice of the present invention include thermoplastic starch, cellulose, polyvinyl alcohol, polylactic acid, polyhydroxyalkanoate, and compostable polyester. However, the present invention is not limited to such materials and may include any environmentally friendly materials now in existence or hereinafter developed.

Polylactic acid (PLA) is manufactured by a few companies, including NatureWorks of Minneapolis, Minnesota. PLA is a thermoplastic resin synthesized from corn starch, and thus is made from a renewable resource. PLA is compostable, as is known in the art.

Polyhydroxyalkanoate (PHA) is manufactured by several providers, including Metabolix of Cambridge, Massachussetts. PHA is isolated from genetically modified bacteria or plants, and thus is made from a renewable resource. PHA is also compostable, as is known in the art.

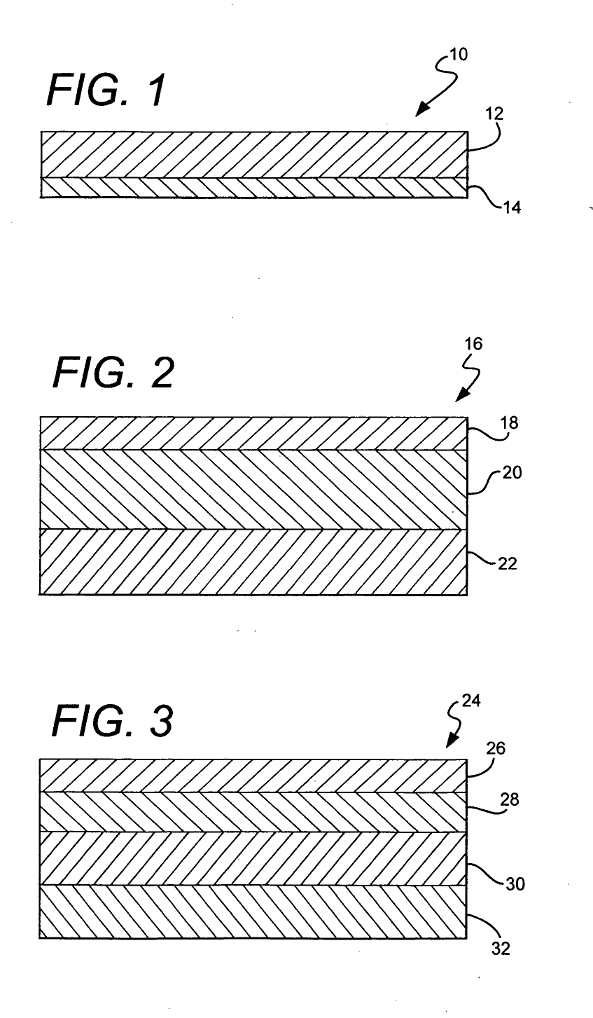

One embodiment of the invention is a two-layer sheet material comprising PLA, as is shown in FIG. 1 and generally designated as reference numeral 10, and includes a first layer 12 and a second layer 14. The first layer 12 is, in one embodiment, relatively thick (as compared to the second layer), and is preferably provided with an additive. The additive may be a colorant, filler, reinforcing agent, or nucleation agent, or any combination of these additives. The colorant may be any colorant, including pigment or dye, that is added by any method, including liquid colorant, color concentrate, and neat colorant. The filler may comprise talc, calcium carbonate, mica, vermiculite, clay, and/or glass bead, and/or any other filler now or hereinafter used in the industry. The reinforcing agent may comprise glass fiber, cloth fiber, carbon fiber, organic or polymeric fiber, and/or metal fiber, including aluminum and stainless steel fiber, or may comprise any other reinforcing agents now or hereinafter used in the industry. The nucleation agent can comprise any agent that induces or accelerates crystallization in a polymer. It will be noted that the present invention is not limited to the additives mentioned above. Indeed, other additives may be used, including clarifiers, internal and external lubricants, and melt strength enhancers.

In one embodiment, the additive includes a colorant that is added in an extruder. However, it will be noted that the colorant may also be added and mixed into the polylactic acid by other means, such as in a polymerization reactor. In addition, the colorant may be added as a liquid or solid color concentrate, or as a neat colorant. The colorant is placed in the first layer 12 in an amount preferably between 0.25% and 10% by weight.

The second layer 14 is also preferably made of a polylactic acid. This second layer 14 is, however, substantially clear, i.e., the second layer 14 is made of an uncolored polylactic acid, such as pure and untreated NatureWorks 2002D.

Preferably, the first layer 12 is substantially thicker than the second layer 14. In the finished sheet material product 10, the first layer 12 may have a thickness in excess of 0.005 inch, and more preferably has a thickness ranging between 0.010 inch and 0.100 inch.

The second layer 14 preferably has a thickness ranging from about 0.0005 inch to about 0.010 inch, and more preferably has a thickness of between 0.001 inch to 0.005 inch. It will be understood, however, that the first layer 12 and second layer 14 may have equal thicknesses and that the present invention is not limited to one layer having a thickness greater than the other layer. Moreover, the present invention is not limited to layers comprising the same environmentally friendly material. Indeed, different environmentally friendly materials may be used in different layers of the sheet material of the present invention. Also, layers of environmentally friendly material may be combined with layers of non-environmentally friendly materials in the practice of the present invention.

The two-layer sheet material 10 is preferably made by extruding the first layer 12 and the second layer 14 together in co-extrusion. However, in addition to co-extrusion, the two layers 12 and 14 may be joined by in-line or off-line extrusion coating, or by in-line or off-line lamination.

One of the advantages of the present two-layer sheet material 10 is that it provides a superior gloss, in comparison with the gloss of prior known polylactic acid sheet materials. As will be seen by the Example below, the two-layer sheet material of the invention has dramatically increased gloss, versus a one-layer base sheet of polylactic acid.

Preferably, the gloss of the clear cap layer of a two-layer sheet material in accordance with the invention is greater than 50, more preferably greater than 60, and most preferably greater than 75, as measured on a Novo-Curve Rhopoint small area glossmeter at a 60 degree measurement angle . In fact, in the most preferred embodiment of the invention, the gloss, as measured on at least one side of the sheet material, exceeds 79.

Another embodiment of the present invention is shown in FIG. 2, wherein the sheet material 16 of one embodiment of the present invention comprises a first layer 18, a second layer 20 and a third layer 22. The first layer 18 preferably comprises an exposed, clear gloss cap layer, and is an environmentally friendly material, such as Natureworks 2002D PLA. The second layer 20 comprises an intermediate layer comprising an environmentally friendly material that includes an additive or additives, as described above, such as colorants, fillers, and/or reinforcing agents, or any combination of these additives. The third layer comprises an exposed environmentally friendly material, which may also include colorants, fillers and/or reinforcing agents added in the same concentration levels used for the second layer. Preferably, the first layer is 0.002 in., the second layer is 0.008 in. and the third layer is between 0.002 and 0.005 in.

Yet another embodiment of the present invention is shown in FIG. 3, wherein the sheet material 24 of the present invention comprises a first layer 26, a second layer 28, a third layer 30 and a fourth layer 32. The first layer 26 comprises a clear gloss cap layer made of environmentally friendly material, such as Natureworks 2002D PLA. The second layer comprises an environmentally friendly material that includes either a colorant, filler, or reinforcing agent, or any combination of these additives. The third layer comprises an environmentally friendly material, which may contain regrind. Finally, the fourth layer comprises an exposed layer of environmentally friendly material that may include an additive or combination of additives, such as colorants, fillers and/or reinforcing agents at levels described for the second layer described above. Preferably, the first layer is 0.002 in., the second layer is between 0.003 in. and 0.004 in., the third layer is between 0.007 and 0.008 in. and the fourth layer is between 0.002 and 0.005 in.

It will be noted that the invention is not limited to the thicknesses of the layers set forth herein and that a wide variety of thicknesses for the layers may be used in the practice of the present invention. Moreover, it will be appreciated by those with skill in the art that a multitude of layers may be used in the practice of the present invention, and that the invention is not limited to sheet material (or products made therefrom) having two, three or four layers. Indeed, it is envisioned that sheet material having five or more layers can be used in the practice of the present invention.

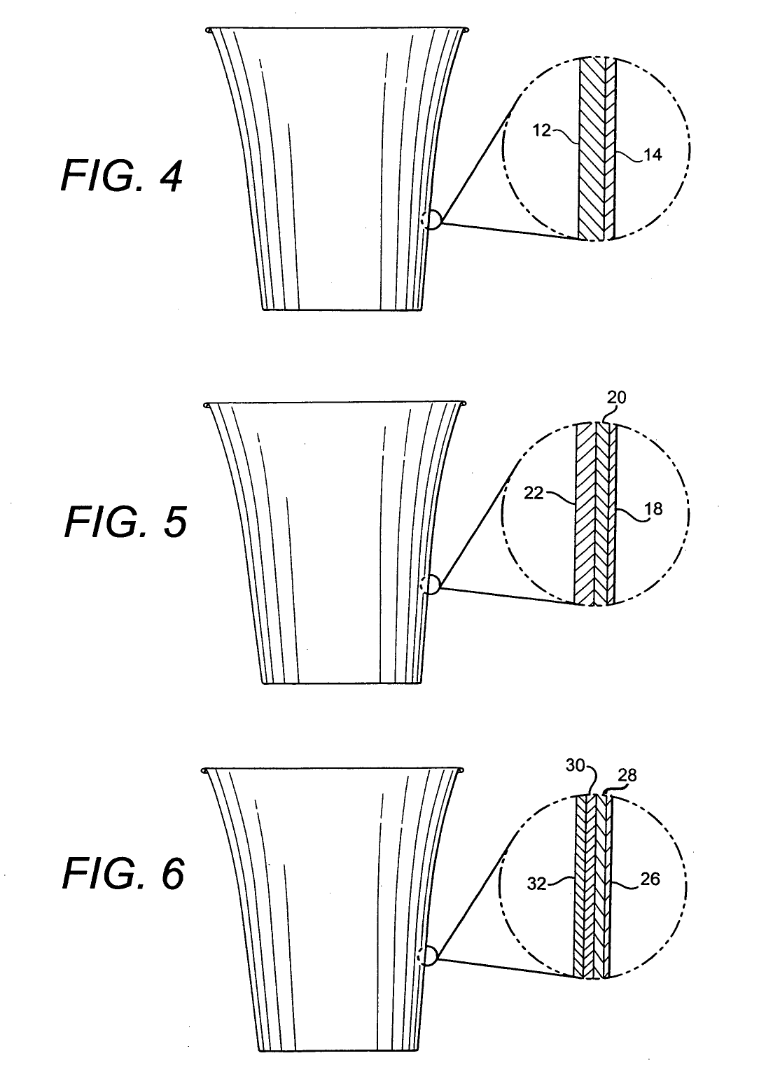

The sheet material of the present invention can be used to make a wide variety of articles, including plates, cups, bowls, delicatessen containers, and take-out containers. By way of example, FIGS. 4-6 show cups manufactured from the two, three and four layer sheet material described herein, respectively.

Embodiments of the present invention will be described in detail in the following examples, where it should be appreciated that the scope of this instant invention is not limited in any way by the description of the embodiments set forth herein. The following specific examples are provided to illustrate further aspects and unique advantages of the present invention, and other features and embodiments should become apparent to those skilled in the art. The examples are set forth for illustration only, and should not be construed as limitations on the scope of the present invention.

### EXAMPLE 1

### Two Layer Sheet

A two-layer sheet of polylactic acid is manufactured by a co-extrusion process. In particular, a Welex tri-layer extrusion system, as is well known in the art, is utilized. Such extruder has a primary extruder and two secondary extruders.

The first or main screw of the Welex primary extruder is a 3.5″, 3-stage barrier screw. The primary extruder extrudes the first layer of the two-layer sheet. The Welex tri-layer extrusion system also includes two, identical 2″ co-extruding secondary extruders. One of the two 2″ co-extruders is used to extrude the second of the two layers of the polylactic acid sheet. The second co-extruder was not used for a two-layer sheet, but would be used for a three-layer sheet, as described above.

The formulation of the first layer (fed through the primary extruder) was ninety-two parts (by weight) of NatureWorks 2002D PLA blended with eight parts (by weight) of the Clariant red color concentrate made with PLA carrier. The Clariant red PLA color concentrate had a 16.7% total colorant loading. Thus, the amount of colorant in the first layer is 1.33%, and the amount of PLA is 98.67%. The 92% PLA/8% red color concentrate blend was extruded through the main extruder. The second layer (fed through the co-extruder) was formulated using neat Nature Works 2002 PLA. The primary extruder, and the one co-extruder, fed their output into a co-extrusion feedblock,

Polylactic acid is highly hygroscopic. In fact, moisture from the atmosphere could be absorbed into the molten polylactic acid during extrusion. Accordingly, to lower the possibility of moisture being absorbed into the extruded polylactic acid sheet layers during their manufacture, the extruder vent was closed.

An 18″ EDI flex lip extrusion die is placed after the co-extrusion feed block at the end of the main extruder of the Welex tri-layer extrusion system. The die had a gap of 0.048 inches. After the two-layer sheet exits the extrusion die, the sheet was passed through a standard roll stack of three 16″ chrome rolls. The roll gap between rolls 1 and 2 was 0.048″ and between rolls 2 and 3 was 0.050″. After the finished sheet passed through the roll stack, the sheet was wound onto a roll.

The roll of two-layer sheet was then fed into an off-line single cavity thermoformer with a five-stop oven. The thermoformer conditions were typical for making single layer PLA products, which conditions are well known in the art. It should be noted that the invention is not limited to an off-line thermoformer and that the two-layer sheet material may be sent directly to an in-line thermoformer. It should be noted that although a roll-fed thermoformer was used in this example, a cut sheet thermoformer may be used in the practice of the present invention.

Tables I, II, III, and IV below list the operating parameters for the Welex extruder during the manufacture of this two-layer sheet.

In particular, Table I provides a heat profile of the main/secondary extruder. Table II provides a heat profile of the chrome roll. Table III lists recorded operating conditions for the extruder and gear pump set Finally, Table IV provides die gap and nip gap dimensions.

TABLE I
Main/Secondary Extruder
Heat Profile

| Extruder Zones | Set PT. |
|---|---|
| Feed Temp | 430 |
| Barrel Zone # 1 | 430 |
| Barrel Zone # 2 | 400 |
| Barrel Zone # 3 | 400 |
| Vent Zone | Plug |
| Barrel Zone # 4 | 400 |
| Barrel Zone # 5 | 425 |
| SC | 375 |
| Body | |
| SC Slide Cyl. | 375 |
| Flange Adapter | 375 |
| Flange # 1 | 375 |
| Flange # 2 | 375 |
| Gear Pump | 375 |
| Flange # 3 | 375 |
| Mixer | 375 |
| Flange # 4 | 375 |
| Adapter | 325 |
| Die Zone # 1 | 325 |
| Die Zone # 2 | 325 |

TABLE II
Chrome Roll Heat Profile

| | Set | |
|---|---|---|
| Zone # | PT. | Actual |
| 1 | 80 | |
| 2 | 95 | |
| 3 | 95 | |
| FPM | | 42 |

| | |
|---|---|
| Sheet Temp | 137 |
| Amps | 2.0 |

TABLE III
Extruder/Gear Pump Set

| | |
|---|---|
| Gear Pump Motor Amp | 4.2 |
| Dynisco PSI | 1200 |
| Extruder Amps | 170 |
| Suction PSI | 1000 |
| Discharge PSI | 1100 |
| = | |

TABLE IV
Gaps

| | |
|---|---|
| Die Gap | .048 |
| Roll # 2 Nip Gap | .050 |
| Dew Point | −48 |

Sixteen (16) ounce red cups were manufactured with the two-layer sheet material of one embodiment of the invention. When these cups were measured using a Novo-Curve Rhopoint small area glossmeter at a 60 degree measurement angle, they showed a gloss of 79.4. These cups were cosmetically acceptable. Particularly, the gloss of these cups compared favorably to control cups made with a single red PLA layer; the gloss of the single layer red cups was 39.1. It is the addition of the second, clear polylactic acid (PLA) layer that provides the superior gloss properties of cups made with the two-layer sheet material of the invention. By way of comparison, polystyrene cups with a PS gloss cap layer have a normal gloss level of 98.1.

Thus, it can be seen that the two-layer sheet material of the invention can be used to manufacture cups having a high level of gloss, and particularly a gloss level that approaches the gloss level of polystyrene cups.

Cups made with sheet material of this invention did not leak, and met applicable standards for both sidewall rigidity and top load compression. Cups made with the sheet material of this invention also met all federal and state regulatory requirements, including those of the federal Food and Drug Administration (FDA), the Coalition of Northeast Governors (CONEG) Model Toxic Legislation, and those of the State of California Proposition 65.

### EXAMPLE 2

### Three-Layer Sheet

In order to manufacture three-layer PLA sheets, the same process steps as set forth in Example 1 were used, except the second co-extruder on the Welex was utilized. The second co-extruder used the same heat profile of the first co-extruder. The formulation of the third layer was ninety-two parts (by weight) of NatureWorks 2002D PLA blended with eight parts (by weight) of the Clariant white color concentrate made with PLA carrier. The Clariant white PLA color concentrate had a 25% total colorant loading.

It will be noted that the sheet material of the invention may be used for purposes other than cups. The sheet material of the invention may be used, for example, in connection with the manufacture of containers, including plates, cups, bowls, delicatessen containers, and take-out containers. The sheet material of the invention may also be used in connection with the manufacture of automotive interior trim.

While the specific embodiments have been illustrated and described, numerous modifications come to mind without significantly departing from the spirit of the invention, and the scope of protection is only limited by the scope of the accompanying Claims.

What is claimed is:

1. A two or more layer sheet material wherein the first layer comprises a environmentally friendly material and an additive, the additive selected from the group consisting of a colorant, a filler, or a reinforcing agent; and the second layer comprises a substantially clear environmentally friendly material.

2. The two or more layer sheet of claim 1, wherein the environmentally friendly material of the first and second layer is the same material.

3. The two or more layer sheet of claim 1, wherein the environmentally friendly material is polylactic acid.

4. The two-layer sheet material of claim 1, wherein the additive is a colorant.

5. The two-layer sheet material of claim 4, wherein the colorant is placed in the first layer in an amount between 0.25% and 10% by weight.

6. The two-layer sheet material of claim 1, wherein the additive is selected from the group consisting of a filler or a reinforcing agent.

7. The two-layer sheet material of claim 1, wherein the filler is selected from the group including talc, mica, calcium carbonate, clay, glass bead, and vermiculite.

8. The two-layer sheet material of claim 6, wherein the filler or reinforcing agent is placed in the first layer in an amount between 5% and 50% by weight.

9. The two-layer sheet material of claim 1, wherein the first layer has a thickness in excess of 0.005 inch.

10. The two-layer sheet material of claim 1, wherein the first layer has a thickness of 0.010 to 0.100 inch.

11. The two-layer sheet material of claim 1, wherein the second layer has a thickness of 0.001 inch to 0.015 inch.

12. The two-layer sheet material of claim 1, wherein the second layer in the final product has a thickness of 0.003 to 0.010 inch.

13. The two-layer sheet material of claim 1, wherein the second layer is co-extruded with the first layer.

14. The two-layer sheet material of claim 1, wherein at least one side of that sheet has a gloss in excess of 50.

15. The two-layer sheet material of claim 1, wherein at least one side of that sheet has a gloss in excess of 60.

16. The two-layer sheet material of claim 1, wherein at least one side of that sheet has a gloss in excess of 75.

17. The two-layer sheet material of claim 1, wherein at least one side of that sheet has a gloss in excess of 79.

18. A compostable three-layer sheet, the first layer comprising an outer, exposed, clear gloss cap layer; the second layer comprising an intermediate layer that includes either a colorant, filler, or reinforcing agent; and the third layer comprising an inner, exposed layer.

19. A compostable four-layer sheet material, the first layer comprising a clear gloss cap layer; the second layer comprising a first intermediate layer including either a colorant, filler, or reinforcing agent; the third layer comprising a second intermediate layer; and the fourth layer comprising an inner, exposed layer.

20. A product containing two or more layers, wherein the first layer comprises a environmentally friendly material and an additive, the additive selected from the group consisting of a colorant, a filler, or a reinforcing agent, and the second layer comprises a substantially clear environmentally friendly material.

21. The product of claim 20, wherein the product is made by extrusion and thermoforming.

22. The product of claim 20, wherein the environmentally friendly material of the first and second layer is the same material.

23. The product of claim 20, wherein the environmentally friendly material is polylactic acid.

24. The product of claim 20, wherein the additive is a colorant.

25. The product of claim 24, wherein the colorant is placed in the first layer in an amount between 0.25% and 10% by weight

26. The product of claim 20, wherein the additive is a filler.

27. The product of claim 26, wherein the filler is selected from the group including talc, mica, calcium carbonate, clay, glass bead, and vermiculite.

28. The product of claim 20, wherein the filler or reinforcing agent is placed in the first layer in an amount between 5% and 50% by weight.

29. The product of claim 20, wherein the first layer in the final product has a thickness in excess of 0.005 inch.

30. The product of claim 20, wherein the first layer in the final product has a thickness of 0.010 to 0.100 inch.

31. The product of claim 20, wherein the second layer in the final product has a thickness of 0.0005 inch to 0.010 inch.

32. The product of claim 20, wherein the second layer in the final product has a thickness of 0.001 to 0.005 inch.

33. The product of claim 20, wherein the second layer is co-extruded with the first layer.

34. The product of claim 20, wherein at least one side of the sheet has a gloss in excess of 50.

35. The product of claim 20, wherein at least one side of the sheet has a gloss in excess of 60.

36. The product of claim 20, wherein at least one side of the sheet has a gloss in excess of 75.

37. The product of claim 20, wherein at least one side of the sheet has a gloss in excess of 79.

38. A compostable product containing three or more layers, the first layer comprising an outer, exposed, clear gloss cap layer; the second layer comprising an intermediate, polylactic acid layer comprising colorant, filler, or reinforcing agent; and the third layer comprising an inner, exposed layer.

39. A compostable product containing at least four layers, the first layer comprising clear gloss cap layer; the second layer comprising a first intermediate layer that includes either a colorant, filler, or reinforcing agent; the third layer comprising a second intermediate layer; and the fourth layer comprising an exposed layer.
